(19) United States
(12) Patent Application Publication
(10) Pub. No.: US 2011/0293347 A1
(43) Pub. Date: Dec. 1, 2011

(54) PAPER DISCHARGE APPARATUS, PAPER DISCHARGE METHOD, IMAGE FORMING APPARATUS AND IMAGE FORMING METHOD

(75) Inventors: Toshiharu Sekino, Shizuoka (JP); Kenji Eoka, Shizuoka (JP); Tsuyoshi Sanada, Singapore (SG)

(73) Assignee: TOSHIBA TEC KABUSHIKI KAISHA, Tokyo (JP)

(21) Appl. No.: 13/033,684

(22) Filed: Feb. 24, 2011

(30) Foreign Application Priority Data
May 31, 2010 (JP) 2010-125258

(51) Int. Cl. B41J 11/42; B65H 20/06; B65H 20/02

(52) U.S. Cl. 400/582; 226/111; 226/4

(57) ABSTRACT

A paper discharge apparatus includes a conveying path configured to convey a paper from an upstream portion to a downstream portion, a feed roller provided on the conveying path, the feed roller configured to convey the paper from the upstream portion to the downstream portion, and a feed belt arranged downstream of the feed roller on the conveying path, the feed belt configured to convey the paper from the upstream portion to the downstream portion. A control unit controls the feed belt and the feed roller to bend the paper by keeping a speed of the feed belt slower than a speed of the feed roller for a period of time, and discharge the paper from the conveying path by keeping the speed of the feed belt to be at least the same speed as the feed roller.

### CROSS-REFERENCE TO RELATED APPLICATIONS

This application is based upon and claims the benefit of priority from Japanese Patent Application No. 2010-125258, filed on May 31, 2010, the entire contents of which are incorporated herein by reference.

### FIELD

Embodiments described herein relate generally to a paper discharge apparatus, a paper discharge method, an image forming apparatus and an image forming method for discharging printed paper after printing is completed.

### BACKGROUND

In general, an image forming apparatus discharges printed papers out of the apparatus through a conveying path by a paper discharge unit provided at an end of the apparatus. Thus, users can take the discharged papers from the apparatus.

If the paper discharge apparatus exposes the papers outside of the apparatus before completing the printing, a user may mistakenly pull the paper out of the apparatus before printing is completed. Therefore, it is desirable that the image forming apparatus or the paper discharge apparatus discharge the papers after completing necessary processes such as printing.

In order to avoid the case where a user mistakenly pulls the paper out of the apparatus before printing is complete, in the paper discharge apparatus or paper image forming apparatus as described above, the printed paper should be discharged outside of the apparatus after completing necessary processes such as the printing.

### BRIEF DESCRIPTION OF THE DRAWINGS

FIG. 1 is a cross-sectional view showing an example configuration of an image forming apparatus according to one embodiment.

FIG. 2 is a block diagram showing an exemplary image forming apparatus according to one embodiment.

FIG. 3 is a cross-sectional view showing a configuration used for printing on a paper in the image forming apparatus.

FIG. 4 is a cross-sectional view showing a configuration used for conveying the printed paper in the image forming apparatus.

FIG. 5 is a cross-sectional view showing a configuration used for bending the printed paper in the image forming apparatus.

FIG. 6 is a cross-sectional view showing a configuration used for cutting the printed paper in the image forming apparatus.

FIG. 7 is a cross-sectional view showing a configuration used for discharging the paper cut in the image forming apparatus.

FIG. 8 is a cross-sectional view showing a stand-by state after the completion of the paper discharge in the image forming apparatus.

FIG. 9 is a cross-sectional view showing a configuration used for collecting the paper within the image forming apparatus.

FIG. 10 is a cross-sectional view showing a state after the completion of collecting the paper within the image forming apparatus.

FIG. 11 is a cross-sectional view showing a configuration used for collecting the paper within the image forming apparatus by using a capture shutter without reverse rotation of a feed motor.

FIG. 12 is a cross-sectional view showing a configuration used for collecting the paper within the image forming apparatus by rotating the feed motor in reveres without using the capture shutter.

FIG. 13 is a cross-sectional view showing a configuration used for collecting the paper within the image forming apparatus by rotating the feed motor in reverse without using the capture shutter.

FIGS. 14A and 14B are perspective views showing an example of the mechanical configuration of the image forming apparatus.

FIGS. 15 to 17 are a flowchart showing an example operation of the image forming apparatus.

### DETAILED DESCRIPTION

According to one embodiment, a paper discharge apparatus includes a conveying path configured to convey a paper from an upstream portion to a downstream portion. A feed roller is provided on the conveying path to convey the paper from the upstream portion to the downstream portion. A feed belt is further provided downstream of the feed roller on the conveying path to convey the paper from the upstream portion to the downstream portion. A control unit keeps a speed of the feed belt slower than a speed of the feed roller for a period of time to allow the paper to be bent. Then, the control unit keeps the speed of the feed belt to be at least the same speed as the feed roller to convey the paper to the downstream of the conveying path to discharge the paper from the conveying path.

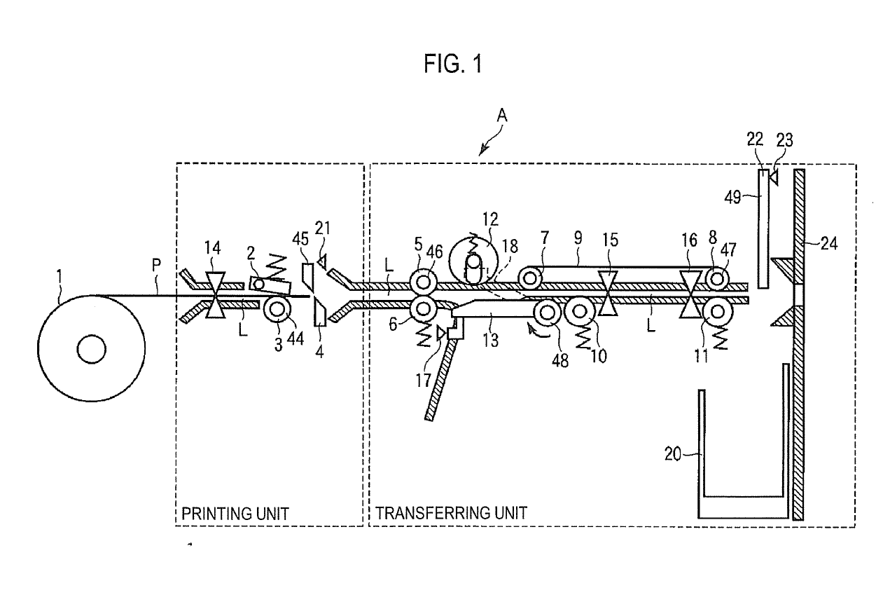

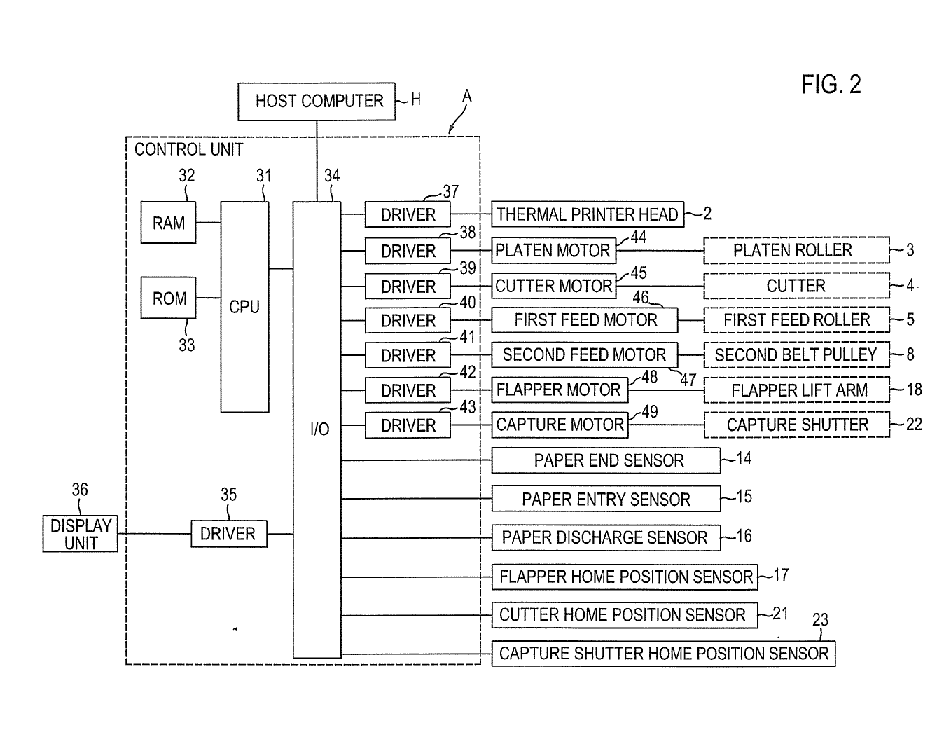

Embodiments will now be described in detail with reference to the drawings. FIG. 1 is a cross-sectional view showing an example configuration of an image forming apparatus, and FIG. 2 is a block diagram showing an exemplary image forming apparatus.

An image forming apparatus (or a paper discharge apparatus) A, as shown in FIG. 1, includes a paper roll 1 for providing a paper P and a conveying path L through which the paper P travels to a downstream portion thereof. In addition, along the conveying path L from an upstream portion thereof to the downstream portion, the image forming apparatus A includes, as elements of a printing unit, a paper end sensor 14, a thermal printer head 2 configured to print characters or the like on the paper P, a platen roller 3 driven by a platen motor 44 located on the opposite side of the thermal printer head 2, a cutter 4 configured to cut the paper P, a cutter motor 45 configured to drive the cutter 4 and a cutter home position sensor 21 configured to detect a home position of the cutter 4.

Further, along the conveying path L from the upstream portion to the downstream portion, the image forming apparatus A includes, as elements of a transferring unit, a first feed roller 5 driven by a first feed motor 46, a first pinch roller 6, a loop roller 12, a flapper 13 configured to provide a space for bending the paper P along the conveying path L, a flapper home position sensor 17 configured to detect a home position of the flapper 13, a flapper motor 48 configured to open the flapper 13, and a lift arm 18 connected to the flapper motor 48. In addition, the image forming apparatus A includes a first belt pulley 7, a second belt pulley 8 connected to the second feed motor 47, a tensioned feed belt 9 extending between the first belt pulley 7 and the second belt pulley 8, a second pinch roller 10, a paper entry sensor 15, a paper discharge sensor 16 provided downstream of the paper entry sensor 15, and a third pinch roller 11 provided at a position corresponding to the second belt pulley 8. The image forming apparatus A further includes a capture motor 49, a capture shutter 22 connected to the capture motor 49, a capture shutter home position sensor 23, a capturing bin 20 in which the paper P may be accommodated by being pushed by the capture shutter 22 and a case 24 of the image forming apparatus having an outlet for discharging the paper P.

FIG. 2 illustrates an electrical configuration of the image forming apparatus A (or a paper discharge apparatus in which the thermal printer head 2 is not equipped) according to one embodiment. As shown in FIG. 2, the image forming apparatus A includes a control unit (or CPU) 31 which controls the entire operation of the apparatus, a RAM 32 and a ROM 33 configured to store control information, operational information, management information and control programs and so on, and an interface (I/O) 34 connected to various drivers 35, 37, 38, 39, 40, 41, 42 and 43 and an external host computer H.

Further, the image forming apparatus A includes a display unit 36 configured to display operational information and management information, the thermal printer head 2 coupled to the driver 37 to print information on a paper P, the platen motor 44 coupled to the driver 38, the platen roller 3 driven by the platen motor 44. The image forming apparatus A further includes a cutter motor 45 coupled to the driver 39, the cutter 4 driven by the cutter motor 45, the first feed motor 46 coupled to the driver 40, the first feed roller 5 coupled to the first feed motor 46, the second feed motor 47 coupled to the driver 41, the second belt pulley 8 coupled to the second feed motor 47. In addition, the image forming apparatus includes the flapper motor 48 coupled to the driver 42, the flapper lift arm 18 coupled to the flapper motor 48, the capture motor 49 coupled to the driver 43 and the capture shutter 22 coupled to the capture motor 49.

Furthermore, the image forming apparatus A includes the paper end sensor 14, the paper entry sensor 15, the paper discharge sensor 16, the flapper home position sensor 17, the cutter home position sensor 21 and the capture shutter home position sensor 23, which are coupled to the interface 34.

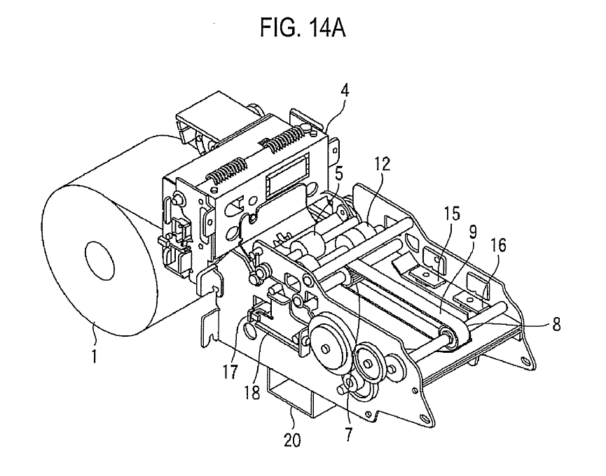

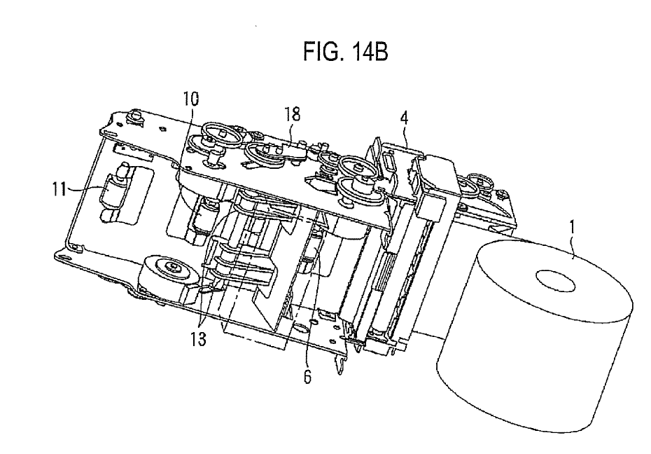

In FIG. 14A and FIG. 14B, example mechanical configurations of the image forming apparatus A (or the paper discharge apparatus) are illustrated. FIG. 14A is a perspective view of the image forming apparatus A, when viewed from the top side thereof, while FIG. 14B is a perspective view of the image forming apparatus A, when viewed from the bottom side thereof, which provides the detailed positional arrangements between the elements described above.

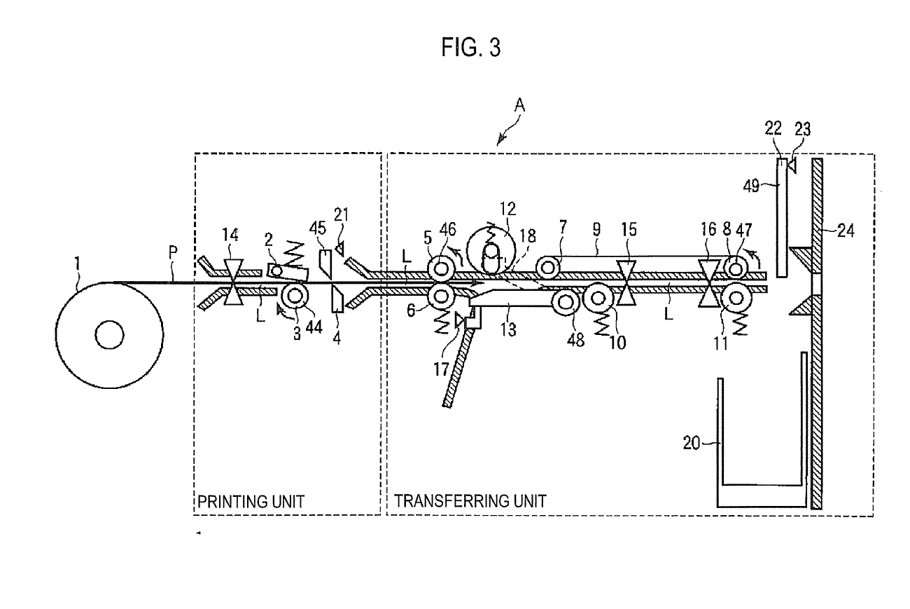

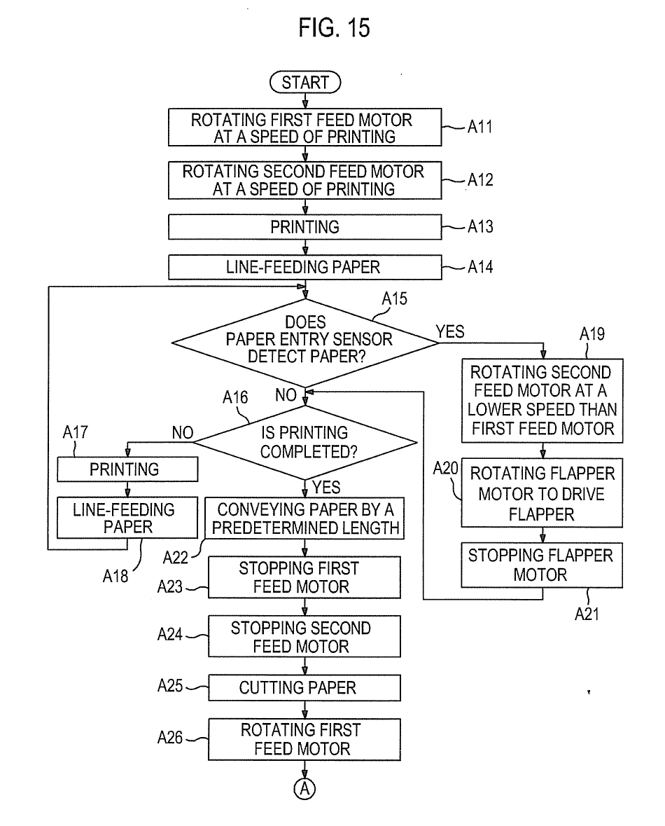

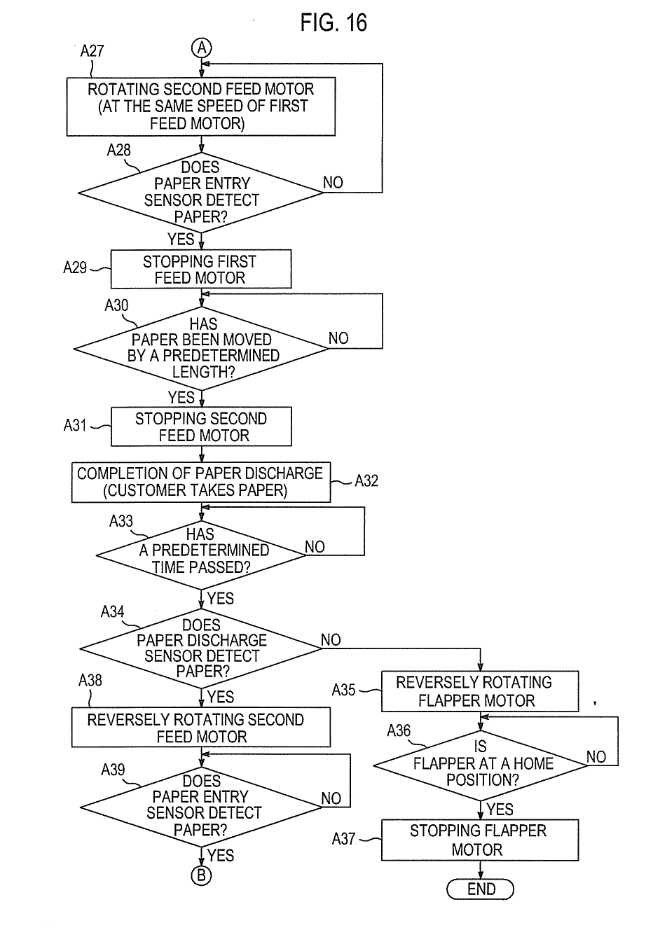

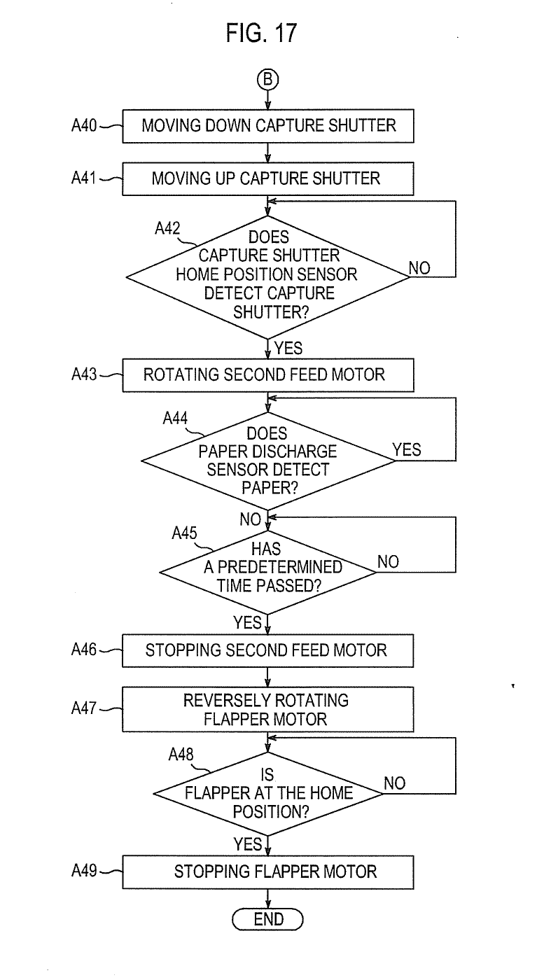

The operation of the image forming apparatus A having the above-described configuration will be explained below in detail with reference to the cross-sectional views of FIG. 1, FIGS. 3 to 12, and the flow charts shown in FIGS. 15 to 17. In the present disclosure, the paper discharge apparatus is operated in the same mariner as the image forming apparatus A except that the image forming apparatus A may further perform a printing function.

First, under the control of the CPU 31, the paper P supplied from the paper roll 1 is conveyed along the conveying path L. The first feed motor 46 rotates at the same speed as that of printing conducted by the thermal printer head 2 (Act A11). Similarly, the second feed motor 47 rotates at the same speed as that of printing conducted by the thermal printer head 2 (Act A12). The thermal printer head 2 prints, for example, one line of characters, on the paper P (Act A13). When the printing of one line is completed, the paper P is line-fed by a distance corresponding to the printed line (Act A14). Then, the paper entry sensor 15 determines if a leading end of the paper P is passing through the paper entry sensor 15 (Act A15).

Under the control of CPU 31, a determination of whether the paper entry sensor 15 detects the paper P and a determination of whether the printing is completed are repeatedly performed until the printing is completed (Act A16), as shown in the cross-sectional views of FIGS. 1 and 3. If the printing is not completed, the thermal printer head 2 continues to print information such as characters on the paper P (Act A17), while the paper P being line-fed by a distance corresponding to the number of printed lines (Act A18). If the printing is completed before the paper entry sensor 15 detects the leading end of the paper P, the paper P is further conveyed by a predetermined length, e.g. by a distance corresponding to m (where m is a natural number) lines of print data (Act A22) and then the first feed motor 46 is stopped (Act A23). The second feed motor 47 is also stopped (Act A24).

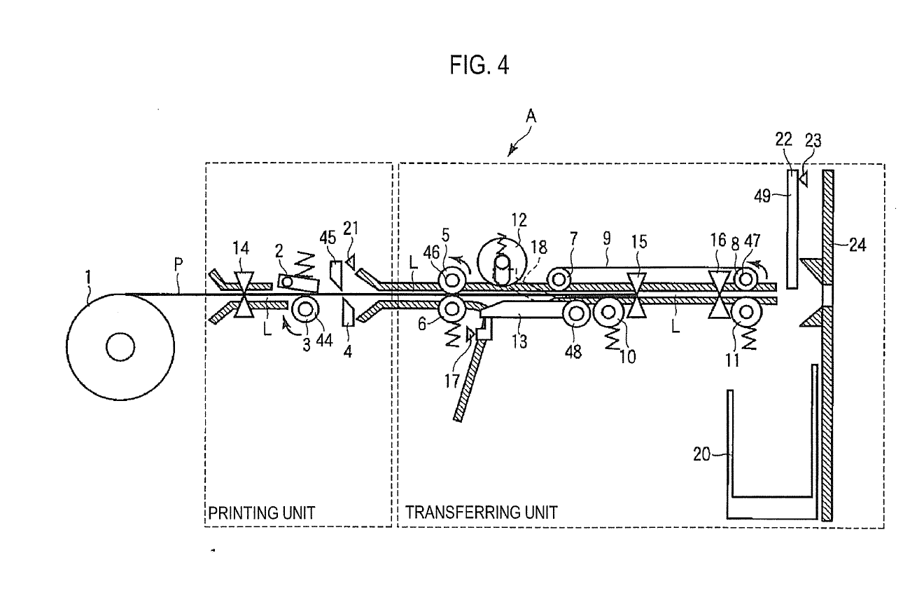

As shown in the cross-sectional view of FIG. 4, when it is determined that the paper P arrives at the paper entry sensor 15 (Act A15) and that the printing is not completed (Act A16), the second feed motor 47 rotates at a lower speed than the first feed motor 46 under the control of CPU 31 (Act A19). Thus, the paper P starts bending because the feed belt 9 rotates slower than the first feed roller 5. Under the control of CPU 31, the flapper motor 48 rotates to drive the flapper 13 to move towards the bottom portion of the apparatus (Act A20). When the flapper 13 is substantially directed towards the bottom portion, the rotation of the flapper motor 48 is stopped (Act A21).

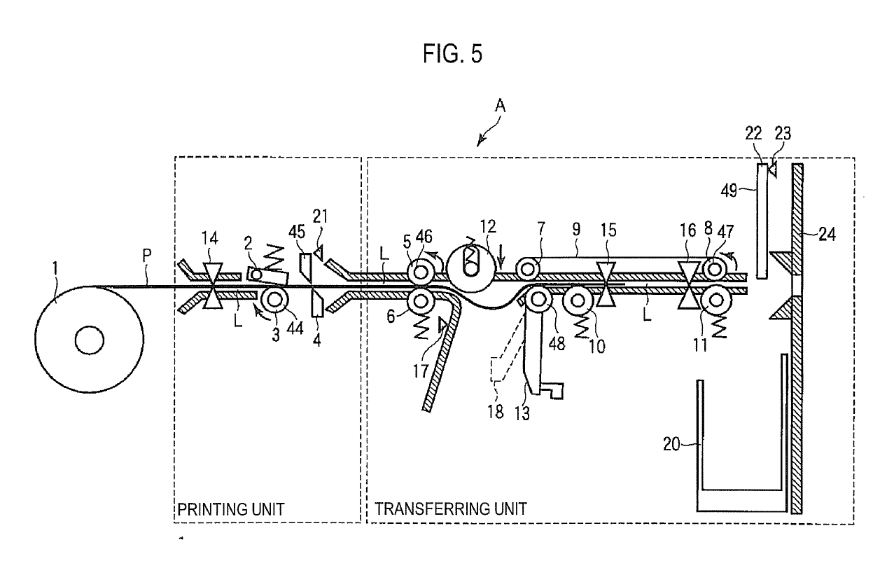

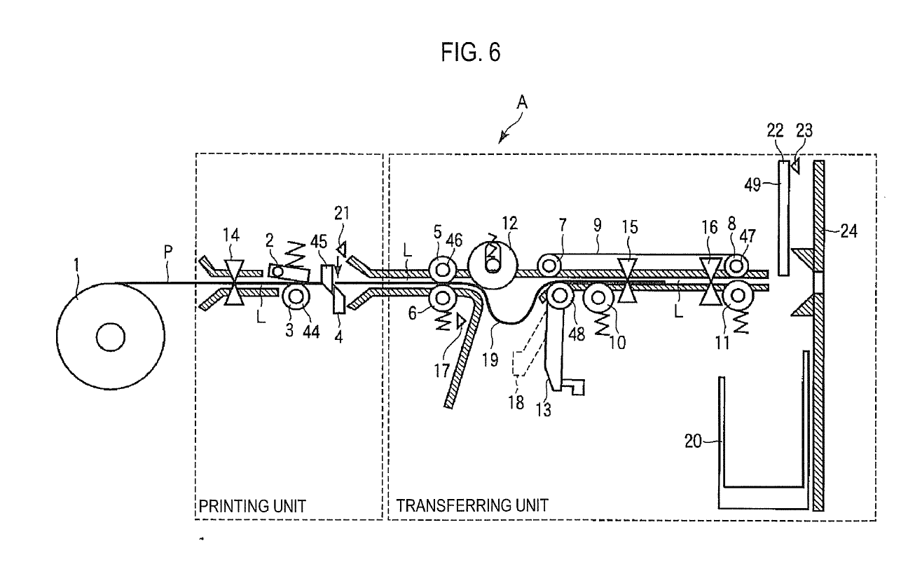

As a result, as shown in the cross-sectional views of FIGS. 5 and 6, the paper P becomes curved enough to avoid the case that the paper P may be exposed through the outlet while the printing is performed. Although the rotational speed of the second feed motor 47 is slower than that of the first feed motor 46, the rotation of the second feed motor 47 is not completely stopped. Therefore, the rotational speed of second feed motor 47 may be immediately restored to be the same as the rotational speed of first feed motor 46. Further, the speed of the feed belt 9 may be immediately accelerated to be faster than that of the first feed roller 5.

When the CPU 31 recognizes that the printing of the paper P is completed (Act A16), the paper P is further conveyed by a predetermined length, e.g. by a distance corresponding to m (where m is natural number) lines of print data (Act A22) and then the first feed motor 46 is stopped (Act A23). The second feed motor 47 is also stopped (Act A24). Thereafter, under the control of the CPU 31, the cutter 4 cuts the paper P (Act A25). Then, under the control of CPU 31, the first feed motor 46 rotates (Act A26) while the second feed motor 47 rotates at the same speed as the first feed motor 46 (or at a speed faster than that of the first feed motor 46) (Act A27).

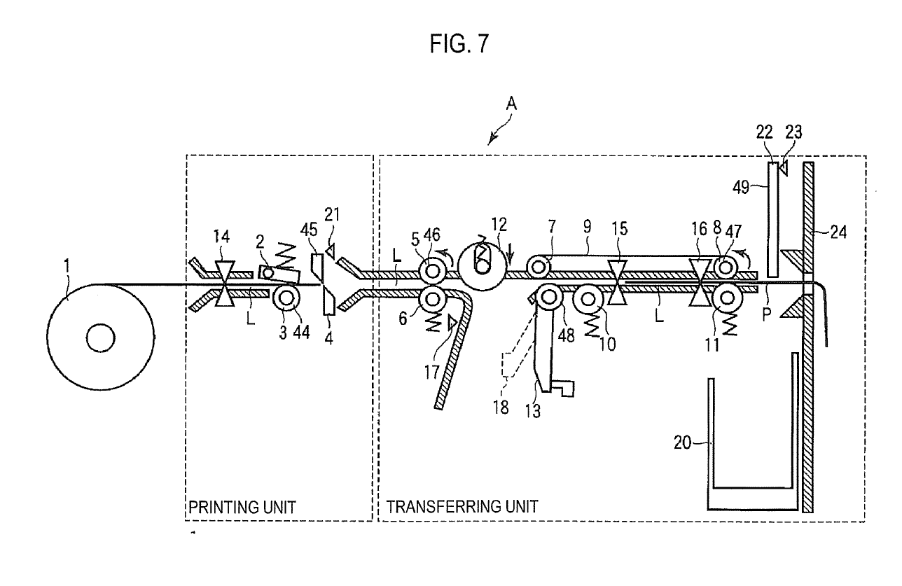

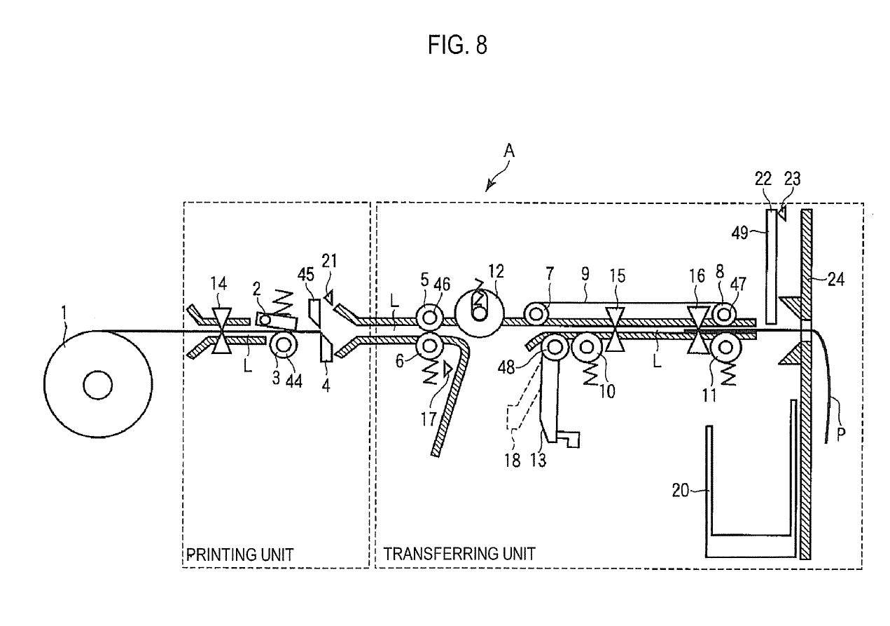

As shown in the cross-sectional view of FIG. 7, when the paper entry sensor 15 detects a rear end of the paper P (Act A28), the CPU 31 stops the rotation of the first feed motor 46 (Act A29). Thereafter, as shown in the cross-sectional view of FIG. 8, when the CPU 31 determines that the paper P has been moved by a predetermined length (Act A30), the CPU 31 stops the rotation of the second feed motor 47 (Act A31). In this situation, the user can take the printed paper P (for instance, a receipt). Thus, during the printing of the paper P, the second feed motor 47 rotates slower than the first feed motor 46, which makes the feed belt 9 rotate slower than the first feed roller 5, while the flapper 13 is configured to move towards the bottom side and form a space along the conveying path L to allow the paper P to be bent. Therefore, exposure of the paper P outside of apparatus can be avoided during printing so that the user is prevented from accidently pulling the paper P out of the apparatus before printing is complete.

In the state shown in the cross-sectional view of FIG. 8, when the CPU 31 recognizes that a predetermined time (for example, one minute) has passed (Act A33) and the paper discharge sensor 16 determines that a user has taken the printed paper P as expected (Act A34), the flapper motor 48 rotates in a reverse direction (Act A35) to move the flapper 13 to its home position, thereby closing the conveying path L. When it is detected that the flapper 13 has closed the conveying path L at its home position (Act A36), the CPU 31 stops the flapper motor 48 (Act A37).

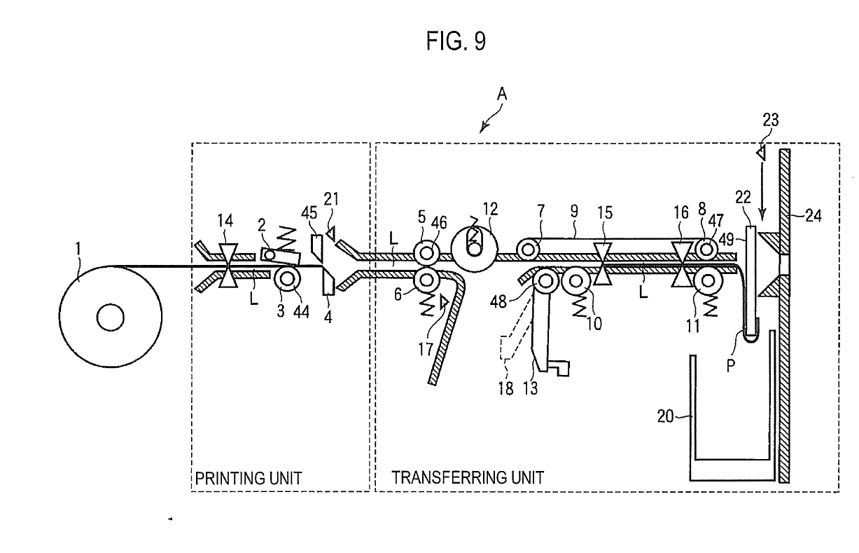

However, in the state shown in the cross-sectional view of FIG. 8, when, based on the detection result from the paper discharge sensor 16, it is determined that the user has not taken the paper P for the predetermined time (for example, one minute) (Act A34), the CPU 31, allows the paper P to be collected inside the case 24. In one embodiment, the CPU 31 rotates the second feed motor 47 in a reverse direction for collection of the paper P (Act A38) until the paper entry sensor 15 detects the rear end of the paper P (Act A39). When the paper entry sensor 15 detects the rear end of the paper P (Act A39), the CPU 31 controls the capture shutter 22 to move downward (Act A40), as shown in the cross-sectional view of FIG. 9. This retracts the paper P from the outlet. Thereafter, the CPU 31 controls the capture shutter 22 to move upward (Act A41) until the capture shutter home position sensor 23 detects the capture shutter 22 (Act A42), and then stops the capture shutter 22.

Then, the CPU 31 controls the second feed motor 47 (Act A43) to rotate forward. The second feed motor 47 continues to rotate (Act A46) until a predetermined time has passed (Act A45) after the paper discharge sensor 16 first detects the non-exist of paper P (Act A44).

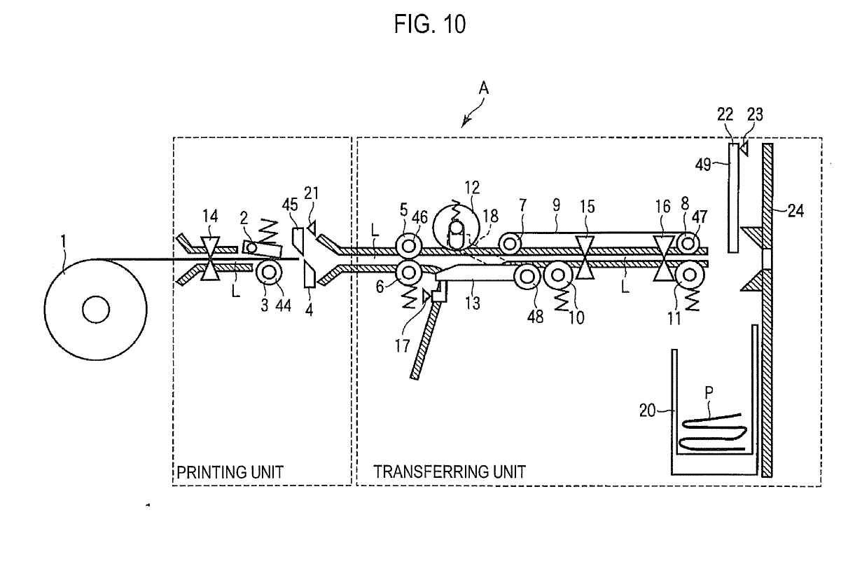

Thus, as shown in the cross-sectional view of FIG. 10, the paper P is discharged out of the conveying path L to be collected into a capture bin 20.

Thereafter, the CPU 31 rotates the flapper motor 48 in a reverse direction to move the flapper 13 upward to close the conveying path L (Act A47). When it is determined (e.g., by the flapper home position sensor 17) that the flapper 13 has closed the conveying path L at its home position (Act A48), the CPU 31 stops the flapper motor 48 (Act A49). Thus, the all operations are completed.

According to the above embodiments, when the user does not take the paper even after the predetermined time has elapsed, the second feed motor 47 is rotated in a reverse direction so that the paper is collected into the capture bin 20 by the capture shutter 22.

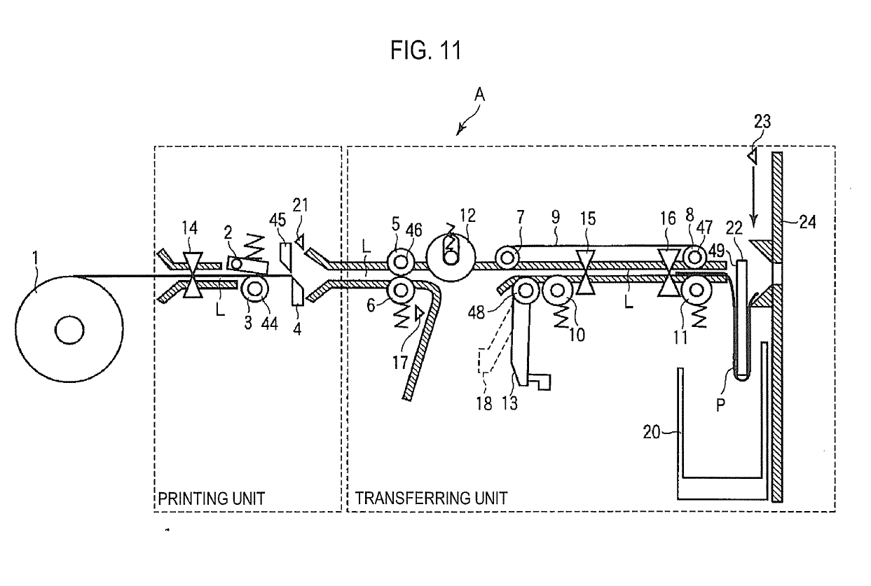

However, the method of collecting the paper may not be limited to the above embodiments. For example, as shown in the cross-sectional view of FIG. 11, when the user does not take the paper P even after the predetermined time has elapsed, the capture shutter 22 may be lowered down to introduce the paper P into the capture bin 20 without rotating the feed motor 47 in a reverse direction. In this way, the paper P can be collected more quickly because it does not require reversing the rotation of the second feed motor 47, compared to the embodiments described above.

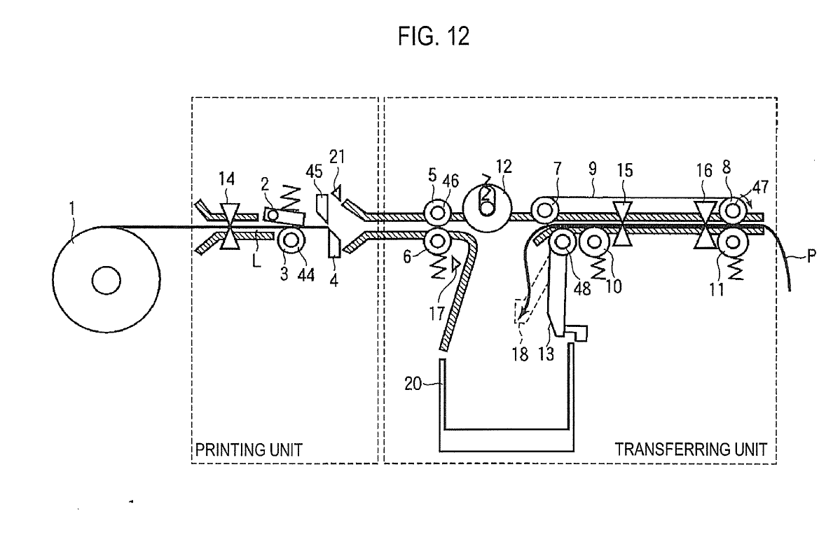

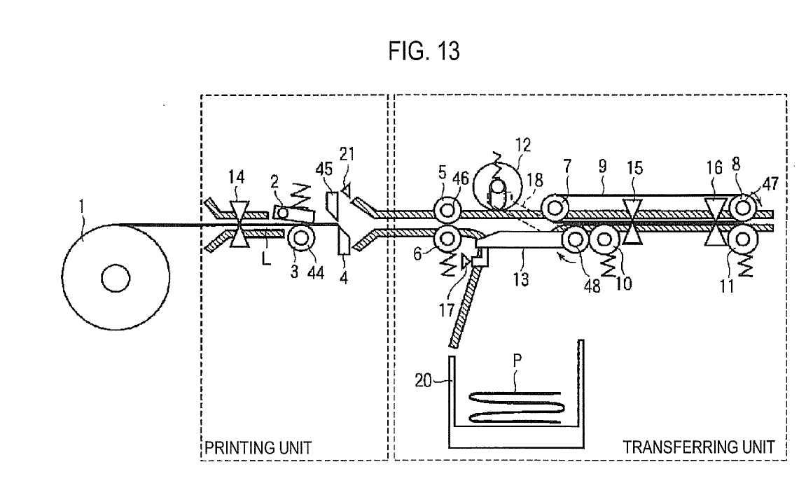

Further, as shown in the cross-sectional view of FIG. 12, the paper P may be collected, without necessitating the capture shutter 22, into a capture bin 20 provided below the flapper 13. In the configuration shown in FIG. 12, when the user does not take the paper P even after the predetermined time has elapsed, the paper P can be collected into the capture bin 20 provided below flapper 13 by rotating the second feed motor 47 in a reverse direction, as shown in FIG. 13.

As mentioned above, in the image forming apparatus A (or paper discharge apparatus) of the embodiments, exposure of the paper P outside the apparatus is prevented while the printing is performed thereon, without necessitating the stopping of the driving units, by employing the configuration in which the feed belt rotates slower than the feed roller. Accordingly, this resolves the problem of a user accidently pulling the paper out of the apparatus before printing has completed. In addition, if the paper P in which printing was completed is not taken by a user, even after the predetermined time period, the paper P is collected inside the case of the apparatus by lowering the capture shutter 22. Thus, trouble such as a jam due to any subsequently discharged paper can be prevented.

Further, in some embodiments when the flapper 13 is controlled to move downward and open the conveying path, the lift arm 18 and the loop roller 12 are lowered at the same time. Thus, the deflected portion of the paper P can be properly guided downward. As a result, the bending of the paper P can be made stably, regardless of the winding direction of the paper roll 1.

As used in this application, entities for executing the actions can refer to a computer-related entity, either hardware, a combination of hardware and software, software, or software in execution. For example, an entity for executing an action can be, but is not limited to being, a process running on a processor, a processor, an object, an executable, a thread of execution, a program, and a computer. By way of illustration, both an application running on an apparatus and the apparatus can be an entity. One or more entities can reside within a process and/or thread of execution and an entity can be localized on one apparatus and/or distributed between two or more apparatuses.

The program for realizing the functions can be recorded in the apparatus, can be downloaded through a network to the apparatus and can be installed in the apparatus from a computer readable storage medium storing the program therein. A form of the computer readable storage medium can be any form as long as the computer readable storage medium can store programs and is readable by the apparatus such as a disk type ROM and a solid-state computer storage media. The functions obtained by installation or download in advance in this way can be realized in cooperation with an OS (Operating System) in the apparatus.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A paper discharge apparatus, comprising:
a conveying path configured to convey a paper from an upstream portion to a downstream portion;
a feed roller provided on the conveying path, the feed roller configured to convey the paper from the upstream portion to the downstream portion;
a feed belt provided downstream of the feed roller on the conveying path, the feed belt configured to convey the paper from the upstream portion to the downstream portion; and
a control unit configured to keep a speed of the feed belt to be slower than a speed of the feed roller for a period of time to allow the paper to be bent, and then keep the speed of the feed belt to be at least the same speed as the feed roller to convey the paper to the downstream portion of the conveying path to discharge the paper from the conveying path.

2. The apparatus of claim 1, wherein the control unit is further configured to collect the paper inside a case of the apparatus if a predetermined time has elapsed after at least a part of the paper is exposed through an outlet provided in the case.

3. The apparatus of claim 1, further comprising:
a case provided at an end of the conveying path and having an outlet for discharging the paper; and
a shutter configured to introduce the paper from the outlet to an inside portion of the case by pushing the paper after at least a part of the paper is exposed through the outlet, the shutter being arranged between the conveying path and the outlet.

4. A method of discharging a paper in a paper discharge apparatus including a conveying path configured to convey a paper from an upstream portion to a downstream portion, a feed roller provided on the conveying path, configured to convey the paper from the upstream portion to the downstream portion, and a feed belt arranged downstream of the feed roller on the conveying path, configured to convey the paper from the upstream portion to the downstream portion, the method comprising:
bending the paper by keeping a speed of the feed belt slower than a speed of the feed roller for a period of time; and
conveying the paper to the downstream portion of the conveying path to discharge the paper from the conveying path by keeping the speed of the feed belt to be at least the same speed as the feed roller.

5. The method of claim 4, further comprising:
collecting the paper inside a case of the apparatus if a predetermined time has elapsed after at least a part of the paper is exposed through an outlet provided in the case of the apparatus.

6. The method of claim 4, further comprising:
collecting the paper inside a case of the apparatus if a predetermined time has elapsed after at least a part of the paper is exposed through an outlet provided in the case of the apparatus by pushing the paper using a shutter arranged between the outlet and the conveying path.

7. An image forming apparatus, comprising:
a conveying path configured to convey a paper from an upstream portion to a downstream portion;
a printing unit configured to perform printing on the paper;
a feed roller provided on the conveying path, the feed roller configured to convey the paper from the upstream portion to the downstream portion;
a feed belt arranged downstream of the feed roller on the conveying path, the feed belt configured to convey the paper from the upstream portion to the downstream portion; and
a control unit configured to keep a speed of the feed belt slower than a speed of the feed roller for a period of time to allow the paper to be bent, and then keep the speed of the feed belt to be at least the same as the speed of the feed roller, after the printing unit completes the printing on the paper, to convey the paper to the downstream portion of the conveying path to discharge the paper from the conveying path.

8. The apparatus of claim 7, further comprising:
a cutter configured to cut the paper,
wherein the control unit keeps the speed of the feed belt to be at least the same as the speed of the feed roller, after the printing unit completes the printing on the paper and the paper is cut by the cutter, to convey the paper to the downstream portion of the conveying path to discharge of the paper from the conveying path.

9. The apparatus of claim 7, further comprising:
a paper entry sensor provided at a position along the feed belt on the conveying path, configured to detect a leading end of the paper,
wherein the control unit starts to keep the speed of the feed belt slower than the speed of the feed roller if the paper entry sensor detects the leading end of the paper.

10. The apparatus of claim 7, further comprising: a flapper provided on the conveying path, the flapper configured to form a space on the conveying path to allow the paper to be bent.

11. The apparatus of claim 7, further comprising:
a case provided at an end of the conveying path and having an outlet for discharging the paper,
wherein the control unit collects the paper inside the case if a predetermined time has elapsed after at least a part of the paper is exposed through the outlet.

12. The apparatus of claim 7, further comprising:
a case having an outlet for discharging the paper by way of the conveying path; and
a shutter arranged between the conveying path and the outlet, the shutter configured to introduce the paper from the outlet into the case by pushing the paper after at least a part of the paper is exposed through the outlet.

13. The apparatus of claim 10, further comprising a loop roller provided between the feed roller and the feed belt, the loop roller configured to move upward or downward in response to movements of the flapper to bend the paper.

14. A method of forming an image in an image forming apparatus including a conveying path configured to convey a paper from an upstream portion to a downstream portion, a printing unit configured to perform printing on the paper, a feed roller provided on the conveying path, the feed roller configured to convey the paper from the upstream portion to the downstream portion, a feed belt arranged downstream of the feed roller on the conveying path, the feed belt configured to convey the paper from the upstream portion to the downstream portion, the method comprising:
bending the paper by keeping a speed of the feed belt slower than a speed of the feed roller for a period of time; and
conveying the paper to the downstream portion of the conveying path to discharge the paper from the conveying path by keeping the speed of the feed belt to be at least the same speed as the feed roller after the printing unit completes the printing on the paper.

15. The method of claim 14, wherein the conveying the paper to the downstream portion is performed after the printing unit completes the printing on the paper and the paper is cut by a cutter.

16. The method of claim 14, wherein the speed of the feed belt is kept to be slower than the speed of the feed roller if a paper entry sensor provided in the feed belt on the conveying path detects a leading end of the paper.

17. The method of claim 14, wherein the paper is bent by movements of a flapper provided on the conveying path to form a space on the conveying path.

18. The method of claim 14, wherein the image forming apparatus further includes:
a case provided at an end of the conveying path and having an outlet for discharging the paper; and
a control unit configured to collect the paper inside the case if a predetermined time has elapsed after at least a part of the paper is exposed through the outlet.

19. The method of claim 18, wherein the image forming apparatus further includes a shutter arranged between the conveying path and the outlet, the method further comprising collecting the paper from the outlet inside the case by pushing the paper after at least a part of the paper is exposed through the outlet.

20. The method of claim 17, wherein the image forming apparatus further includes a loop roller provided between the feed roller and the feed belt, and the paper is bent by movements of the loop roller in response to the movements of the flapper.
